(19) United States
(12) Patent Application Publication
(10) Pub. No.: US 2002/0180074 A1
(43) Pub. Date: Dec. 5, 2002

(54) Solid surface evaporative cooler

(76) Inventor: Willard H. Schmidt, Albuquerque, NM (US)

Correspondence Address: Willard H. Schmidt, 2015 Altez NE, Albuquerque, NM, 87112, US

(21) Appl. No.: 09/872,618

(22) Filed: Jun. 4, 2001

(51) Int. Cl. B01F 3/04

(52) U.S. Cl. 261/112.1; 261/DIG. 3; 261/DIG. 43

(57) ABSTRACT

A device to cool a channeled current of ambient air, utilizing the water heat of vaporization, by means of evaporating water from a solid material surface of any configuration. From a water distributor assembly 4, water is sprayed through water spray outlets 5 onto a conical evaporation surface 7, and evaporated by a current of air in a channel between this surface and the outer shroud 6, or between other evaporation surfaces 8,9 in stacked evaporation surface designs. Air is sucked from under the air inlet hood 3, at the top of the assembly, into the evaporation channel by air fan assembly 1 powered by an electric motor 2. Both are located in a protected position under conical evaporation surface 7. Excess moisture in the air current is drained into a water reservoir assembly 10 as the airflow is turned abruptly upward into the air fan assembly 1, and then into the building air duct 14. A water pump 12, located in sump 11, sends water through the water line 13 to the water distributor assembly 4.

### BACKGROUND

1. Field of Invention

It has become common practice for many homes and business to use some type of air conditioning to make the indoor environment more comfortable during periods of high temperature outside. This is especially true for the warmer regions in every modern country. Even in the cool or cold regions of the world, some form of comfort air conditioning can usually be found.

Where the temperature permits, it is common practice in many areas to just open a window or a door and let the cool breezes blow through the building. This is the simplest form of air conditioning for a building, and it is the least expensive. Simplicity and energy conservation are two extremely important parameters that govern air conditioning choices. Another simple and inexpensive means of limited temperature control is accomplished by just eliminating or reducing sources of heat both inside and outside of the building. Light is a form of energy, and this energy is readily transmitted into heat when absorbed by material. Therefore, heat sources inside of the building can be minimized or eliminated by simply preventing sunlight from entering into a building.

Frequently, the outside air at night is cooler than the air inside of a building. Consequently, a very economical way to effect cooling inside of a building is to simply open the doors and windows to let the cool air from outside circulate into the building. Because the cost of cooling the air inside of a building is expensive, it has been found that simple and straightforward methods promote energy conservation and are the most cost effective.

Just about everyone is aware of the heat of vaporization of water whether realizing it or not. Who hasn't blown their breath over the surface of a cup of hot coffee or a spoon of hot soup in an effort to cool it? Heat is required to vaporize a liquid. When this heat for vaporization is supplied by the liquid itself, the temperature of the liquid is reduced. It is that simple. Water bags have been used for many years to store and cool water. The water container is made of a material that allows water to permeate to the surface of the bag and evaporate in the air to effect cooling of the contents. Industrial plants of many kinds use water sprays to cool the coils of refrigeration equipment. Water cooling towers are used to get rid of excess heat from power plants. These cooling processes rely on and use the heat of vaporization of water to effect cooling. The condensation trails behind high altitude aircraft, and even the condensation of your breath in the air on a cold day, are further common examples that demonstrate the effect of the heat of vaporization of water. An impressive demonstration of heat loss from a surface due to the vaporization of water occurs when a person stands soaking wet in a current of air or wind. The chill is very noticeable.

There are many examples in nature of cooling effects due to the vaporization of water. Need I mention sweating to cool the surface skin of the human body? Water vapor pressure is the pressure exerted when the liquid is in equilibrium with its own vapor. When air pressure on water is reduced below the vapor pressure, water will tend to evaporate. The heat of vaporization will cool the liquid. Every element, molecule, and compound has a vapor pressure, and cooling always results when evaporation takes place. There are many exciting examples of the consequences of vaporization cooling effects in the sun, super nova explosions, and even the Big Bang that created our universe.

The cooling effects that result from the vaporization of water are used to provide a physical basis for cooling the air inside of buildings in order to make living conditions more comfortable for the occupants.

2. Description of Prior Art

Air conditioning systems for buildings can be classified as open or closed loop systems. The coolant in closed loop systems goes through repeated cycles of pressurization and evaporation, and none of the coolant is lost. In open loop systems the coolant is almost always water, and it is lost to the atmosphere as a result of evaporation. This subject invention is an open loop system.

Open loop air conditioning systems are commonly called evaporative coolers or swamp coolers. These are very simple systems in which water is evaporated in order to lower the temperature of the water. The cooled water can then cool ambient air with which it is brought into contact.

In practice today, evaporative coolers are equipped with air filters through which ambient air is pumped and forced to pass in contact with a trickle of water in the filter. The filters are vertical, and water trickles by the force of gravity through the filter from top to bottom. The filter materials that are used include just plain straw, various foam materials, and various woven materials. The process of filtering air through a material in contact with a trickle of water is not an efficient method of cooling the air to be used for air conditioning a building.

In present practice, evaporative coolers commonly have several vertical panels arranged around a squirrel cage air fan, electric motor, water pump, float valve, and water reservoir. All of these components are subject to adverse effects from the high humidity environment in which they are located. The filter panels require regular servicing due to deterioration, residue buildup, and corrosion. These panels are heavy, difficult to remove, and difficult to install. Replacing the filter material in the panels is difficult, and presents a health hazard due to the particulate matter and dust which is released during the operation. Maintenance operations on these evaporative coolers must be considered very dangerous since the unit is often located on top of a roof, and there is always a risk of electrical shock because of the close proximity of the electric conductors and grounded water supply. Because of the rapid deterioration of present practice evaporative coolers, these units must be replaced every few years. Replacement of present day evaporative coolers is a difficult, dangerous, and expensive operation.

A major disadvantage of present practice evaporative coolers is the fact that the air, which is ducted into a building, is continuously passed through dirty wet filters in which bacteria and viruses are known to grow. This presents enormous health hazards to the occupants of the building who breathe the contaminated air into their lungs, and has resulted in the deaths of many people over the years.

Objects and Advantages

The subject patent evaporative cooler requires no air filters for the cooling of the air to be ducted into a building. Consequently, air contamination from filters is completely eliminated, and a major health hazard is eliminated. The cool air from this patent evaporative cooler is much healthier for the building occupants to breathe than the air from present practice units.

Air is cooled in this patent evaporative cooler by causing a current of air to flow over a wet solid surface. The design is simple, and provides for easy assembly and maintenance. Maintenance is expected to be minimal. The electric motor and fan to move the air are located in a shielded region under the evaporation surface that is safe from water runoff. The fan pulls air over the evaporation surface and directly into the air duct into the building. Cooling water is directed or sprayed directly onto the cooling surface and into the cooling air, unlike present practice that utilizes air-cooling filters. Because of its low profile conical shape, this patent evaporative cooler is less of an Eyesore on top of a roof and is less subject to wind damage.

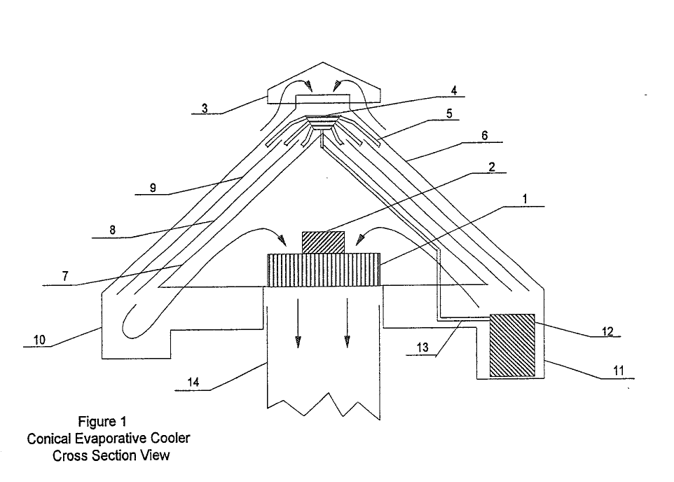

### DRAWING FIG. 1

Conical Evaporative Cooler

### REFERENCE NUMERALS IN DRAWING

1. Air fan assembly

2. Electric motor

3. Air inlet hood

4. Water distributor assembly

5. Water spray outlets

6. Outer shroud

7. Conical evaporation surface

8. Second evaporation surface

9. Third evaporation surface

10. Water reservoir assembly

11. Sump

12. Water pump

13. Water line

14. Airduct

### DESCRIPTION PF CONICAL EVAPORATIVE COOLER FIG. 1

FIG. 1 is a cross section view of a conical shaped solid surface evaporative cooler. This particular design has conical evaporation surface 7, under a second evaporation surface 8, and a third evaporation surface 9. An outer shroud 6 serves as a protective cover over the evaporation surfaces 7, 8, and 9. Cooling water is pumped from the water pump 12, located in sump 11, through the water line 13 to the water distributor assembly 4. Water is directed through the water spray outlets 5 onto the respective solid evaporation surfaces 7, 8, and 9. Excess water drains into the water reservoir assembly 10. Ambient air enters the evaporative cooler under the air inlet hood 3, and is sucked over the evaporation surfaces 7, 8, and 9 by the air fan assembly 1 powered by the electric motor 2. Cool air is driven by the air fan assembly 1 into the air duct 14.

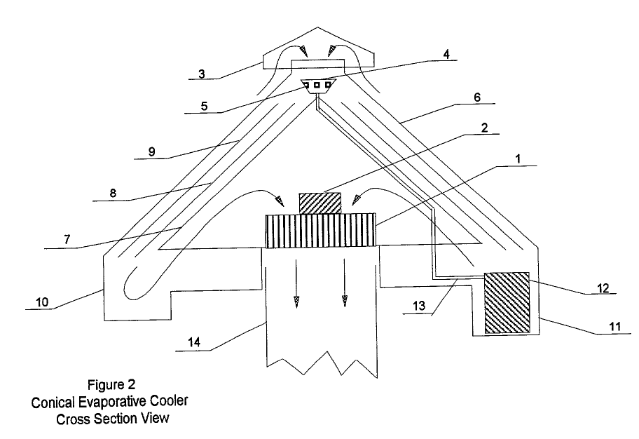

### DRAWING FIG. 2

Conical Evaporative Cooler

### Reference Numerals in Drawing

This drawing is the same as FIG. 1 except that the water spray outlets 5 are illustrated as spray nozzles in the water distributor assembly 4.

### Description of Conical Evaporative Cooler FIG. 2

The description of FIG. 2 is the same as FIG. 1, and the illustration shows water spray nozzles, as mentioned above.

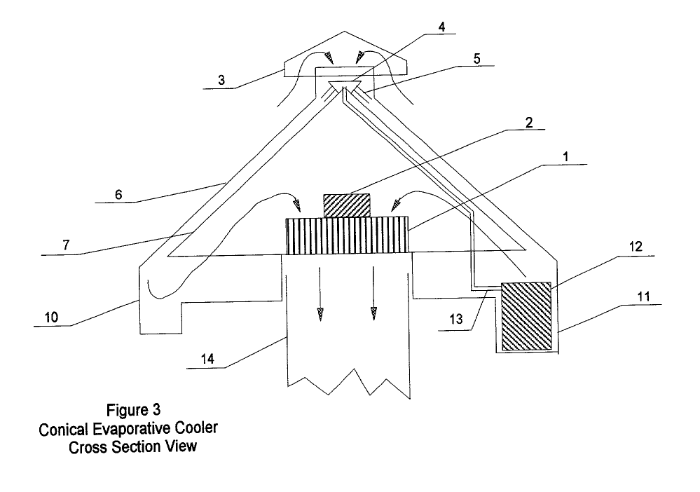

### DRAWING FIG. 3

Conical Evaporative Cooler

### Reference Numerals in Drawing

1. Air fan assembly

2. Electric motor

3. Air inlet hood

4. Water distributor assembly

5. Water spray outlets

6. Outer shroud

7. Conical evaporation surface

10. Water reservoir assembly

11. Sump

12. Water pump

13. Waterline

14. Air duct

### Description of Conical Evaporative Cooler FIG. 3

FIG. 3 is a cross section view of the simplest design of a conical evaporative cooler with only a single water evaporation surface 7. The water distributor assembly 4 is shown with water spray outlets 5 protruding from it. The other elements in the drawing are the same as described for FIG. 1 and FIG. 2. The second and third water evaporation surfaces shown in the previous drawings have been eliminated for FIG. 3, to simplify the design and operation of the unit.

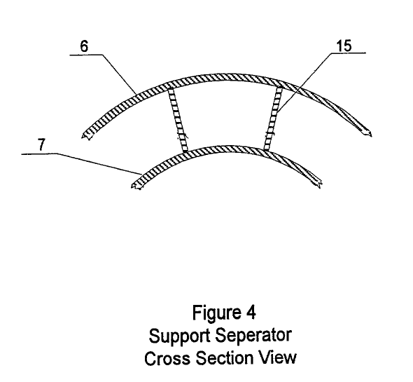

### DRAWING FIG. 4

Support Separator

### Reference Numerals in Drawing

7. Conical evaporation surface

6. Outer shroud

15. Support separator

### Description of Support Separator Drawing FIG. 4

FIG. 4 is a cross section view that shows the air channel which is maintained by the support separator 15, between the conical evaporation surface 7 and the outer shroud 6, as referenced in FIG. 3. In FIGS. 1 and 2, the support separators 15, are located between the conical evaporation surface 7 and the second evaporation surface 8, and between the second evaporation surface 8 and the third evaporation surface 9, and between the third evaporation surface 9 and the outer shroud 6.

Operation

Simplicity is the key word for the design and operation of the solid surface evaporative coolers. This is especially true for the conical configurations shown in the above mentioned figures.

The basic physical principal on which solid surface evaporative coolers operate is that water requires energy to evaporate, and this loss of energy cools the surface that is in contact with the water. The quantity of heat, or unit energy, required to convert a unit mass of liquid to the vapor state without change of temperature is called the heat of vaporization. For water the heat of vaporization is 539 calories per gram or 970 Btu per pound near the boiling point. The heat of vaporization is temperature and pressure dependent. The basic point is that when water evaporates from a material surface the temperature of this surface is lowered as a result.

The conical solid surface evaporative cooler is an expression of the most fundamental and efficient design for application of the water heat of vaporization principal to cool ambient air for use by occupants in buildings.

With reference to FIG. 3, water is sprayed over the solid conical evaporation surface 7, and evaporated in a current of air that is drawn over it by the air fan assembly 1. This fan is powered by an electric motor 2. The cooled air is directed into the building air duct 14. The process of evaporation of the water on the conical evaporation surface 7 is enhanced by the fact that a narrow air channel is formed over the evaporation surface by the outer shroud 6. It is also conical in shape, and fits over the conical evaporation surface 7 with only a narrow channel between. Support separators 15, as shown in FIG. 4 maintain this narrow air channel. These support separators 15 are oriented so as to provide minimal air resistance to the air current in the channel.

Water is sprayed into this air channel and onto the conical evaporation surface 7 from water spray outlets 5 that come from the water distributor assembly 4. The water is pushed over the conical evaporation surface 7 by the current of air in the air channel, and excess water is drained by gravity into the water reservoir assembly 10 located at the base of the assembly. This excess water drains into the sump 11 where the water pump 12 is located. Water is pumped through the water line 13 to the water distributor assembly 4 located near the top of the assembly. Air is sucked into the evaporative cooler from an opening under the air inlet hood 3 located at the top of the assembly. Excess water in the cooled air is forced out of the air stream and into the water reservoir assembly 10 by the sharp upward turn which the cooled air current is forced to make as it leaves the air channel and moves to the air fan assembly 1.

The same operation philosophy holds for the multi air cooling channels in the evaporative cooler designs illustrated by FIGS. 1 and 2, as for FIG. 3.

Summary, Ramifications, and Scope

This patent Solid Surface Evaporative Cooler operates on a sound and basic physical principal, produces healthy clean cool air, is economical to manufacture, and economical to operate. It is designed to replace present day evaporative coolers that are difficult and dangerous to maintain, and exhaust air from dirty wet air filters into buildings where occupants breathe this unhealthy air into their lungs.

This patent evaporative cooler evaporates water from a solid surface in a current of channeled clean air. The current of air is cooled due to the heat of vaporization of water that is on the evaporation surface of the cooler assembly. No air filters are required. The evaporation surfaces can be conical in shape. This contributes to economical manufacture, simple operation, and minimal maintenance. The conical shape of the unit permits the conical evaporation surfaces to be stacked one upon the other for greater cooling capacity and presents a low profile on the roof of a building.

I claim:

1. An evaporative air cooler in which a current of air is cooled, due to the heat of vaporization of water, by passing moving air confined in a channel over a solid wet surface.

2. The cooling effect of water ejected or sprayed onto the solid surface of claim 1 is enhanced by the evaporation of water droplets in the channeled stream of moving air, due to the heat of vaporization of water.

3. Evaporation of the water and water droplets in the moving air of claim 1 is enhanced by a reduction in air pressure, which promotes evaporation, as the air moves along the channel from the inlet to the outlet of the channel.

4. The shape of the solid evaporation surface for water of claim 1 may be conical, flat, or any other configuration.

5. The channel for the air moving over the solid evaporation surface for water of claim 1 is formed by a space between this solid cooling surface and another adjacent surface of similar geometry, that is also a cooling surface, which covers or envelopes the first solid cooling surface.

6. The space for the air channel between the adjacent solid cooling surfaces in claim 1 is obtained by the use of spacers between the respective solid cooling surfaces, and aligned so as to minimize air resistance, or by means of mechanical supports at the extremities of the surfaces, or both.

7. The cooling effect of the moving air in claim 1 is achieved by the introduction of water into the air channel between the solid cooling surfaces.

8. Water injected into the air cooling channel(s) of claim 1 may be introduced onto the solid cooling surface(s) by means of a series of tubes directed at the solid cooling surfaces, or sprayed into the air channel and onto the solid cooling surfaces.

9. In order to excite turbulent airflow in the air channel(s) between the solid cooling surfaces of claim 1 to enhance evaporation of the cooling water, the solid cooling surfaces are dimpled, corrugated, or have flow impediment structures attached to them.

10. Cooling water in the evaporative air cooler of claim 1 circulates in an open loop system that includes a water pump, to move water from a sump through a tube to the water distributor located at the top of the cooling channel assembly, and a sump at the bottom of the cooling channel assembly to collect water which drains by gravity from the cooling channel assembly.

11. Air circulation in the evaporative air cooler of claim 1 is achieved by an air fan located inside and at the bottom of the air cooling channel assembly that can have a conical, or any other, configuration.

12. The air fan for the evaporative air cooler of claim 1 draws air through an inlet opening at the top of the air cooling channel assembly, and sucks it past the water distributor at the top of the assembly, pulls it through the air cooling channels between the solid cooling surfaces, and ejects the cooled air into an air conditioning duct.

13. The air fan and electric motor of claim 1 are located in a shielded and protected region under the conical solid evaporation surface.

14. Excess water in the circulating air that flows out of the air cooling channels in claim 1 is discharged into a collecting channel, or reservoir, located at the bottom of the air cooling channel assembly, as the circulating cooled air from the cooling channels is directed abruptly upward into the region of the circulating air fan.

15. The inlet air opening at the top of the cooling channel assembly in claim 1 is protected and covered by a hood assembly.

16. The cooling channel assembly of claim 1, can consist of any number of solid cooling surfaces and air cooling channels that are stacked one on top of another.

17. The solid cooling surfaces of claim 1 can be covered with a water absorbing material to promote water retention, evaporation, and air cooling.

18. The outer surface, or outer shroud, of the cooling channel assembly of claim 1 can be covered with a heat insulating material to minimize heat transfer from the ambient air into the air cooling channel assembly.
